(19) United States
(12) Patent Application Publication
(10) Pub. No.: US 2011/0149608 A1
(43) Pub. Date: Jun. 23, 2011

(54) ELECTRICAL POWER CONVERTERS AND METHODS OF OPERATION

(75) Inventor: Hans Halberstadt, Groesbeek (NL)

(73) Assignee: NXP B.V., Eindhoven (NL)

(21) Appl. No.: 13/059,412

(22) PCT Filed: Aug. 12, 2009
(86) PCT No.: PCT/IB09/53561

§ 371 Date: Feb. 16, 2011

(30) Foreign Application Priority Data
Aug. 21, 2008 (EP) 08105096.5
Aug. 12, 2009 (IB) PCT/IB2009/053561

(51) Int. Cl. H02M 3/335

(52) U.S. Cl. 363/21.02

(57) ABSTRACT

An electrical power converter includes a transformer (4) with a primary circuit and a secondary circuit. Detecting circuitry is employed to compute a signal representative of the output current in the secondary circuit, and this signal controls the timing of the switching function of rectification switches (49,50) which rectify the secondary AC signal.

This invention relates to electrical power converters and to methods of operation of such converters.

An electrical resonant power converter has a transformer with a primary circuit and a secondary circuit having rectification switches for rectifying the secondary AC signal. The timing of these switches is important because it has a bearing on the losses occurring in the switches and therefore on overall efficiency. In particular, the timing of the switching off is difficult to achieve with accuracy, a matter with which the invention aims to deal.

According to a first aspect of the invention, there is provided an electrical resonant power converter comprising a transformer having a primary circuit and a secondary circuit, the primary circuit being energisable by an AC signal to induce a secondary AC signal across the secondary circuit for delivering an output current, and detecting circuitry for deriving an electrical signal representative of the output current, wherein the secondary circuit has rectification switches having a switching function for rectifying the secondary AC signal and control circuitry for controlling the timing of the switching function in dependence upon the variation with time of the magnitude of the electrical signal representative of the output current.

By recourse to the invention, the output current can be represented with sufficient amplitude to make fast comparator action possible, opening the way for digital control of the rectification switches. The detecting circuitry does not require a signal representative of the primary current and operates on the secondary side of the transformer.

Preferably, the detecting circuitry includes auxiliary winding circuitry associated with the transformer, the detecting circuitry deriving the signal representative of the output current from a sensed voltage across the auxiliary winding circuitry.

The auxiliary winding circuitry may comprise two auxiliary windings in series or anti-series, or may comprise a single auxiliary winding in which the components of the voltage across the magnetising inductances cancel.

The auxiliary winding circuitry may, in certain embodiments, be provided by first and second windings of the secondary circuit.

The detecting circuitry is preferably configured to derive the electrical signal representative of the output current from a difference or sum of voltages across the two auxiliary windings.

The detecting circuitry preferably comprises an integrator connected to the auxiliary winding circuitry, the integrator being configured to integrate a voltage sensed from the auxiliary winding circuitry to provide the electrical signal representative of the output current.

According to a second aspect of the invention there is provided a method of operating an electrical resonant converter comprising a transformer having a primary circuit and a secondary circuit, the primary circuit being energized by an AC signal to induce a secondary AC signal across the secondary circuit for delivering an output current, the method comprising deriving from the secondary circuit an electrical signal representative of the output current and employing the variation (with time) of the electrical signal representative of the output current to control the timing of the switching function of rectification switches which rectify the secondary AC signal.

According to a third aspect of the invention there is provided an electrical power converter comprising:
a transformer having a primary circuit and a secondary circuit, the primary circuit being energisable by an AC signal to induce a secondary AC signal across the secondary circuit for delivering an output current; and
detecting circuitry for deriving an electrical signal representative of the output current, the detecting circuitry comprising an inductor in series with the secondary circuit of the transformer;
wherein the secondary circuit has one or more rectification switches having a switching function for rectifying the secondary AC signal and control circuitry for controlling the timing of the switching function in dependence upon the variation with time of the magnitude of the electrical signal representative of the output current.

The electrical power converter is preferably a resonant converter or a flyback power converter. As with embodiments according to the first aspect of the invention, the detecting circuitry may comprise an integrator connected to the inductor, the integrator configured to integrate a voltage sensed across the inductor to provide the electrical signal representative of the output current.

According to a fourth aspect of the invention there is provided a method of operating an electrical power converter comprising a transformer having a primary circuit and a secondary circuit, the primary circuit being energised by an AC signal to induce a secondary AC signal across the secondary circuit for delivering an output current, the method comprising deriving an electrical signal representative of the output current from a voltage measured across an inductor in series with the secondary circuit of the transformer and employing the variation with time of the electrical signal representative of the output current to control the timing of the switching function of one or more rectification switches which rectify the secondary AC signal.

Embodiments of the invention will now be described, by way of example, with reference to the accompanying drawings, in which:

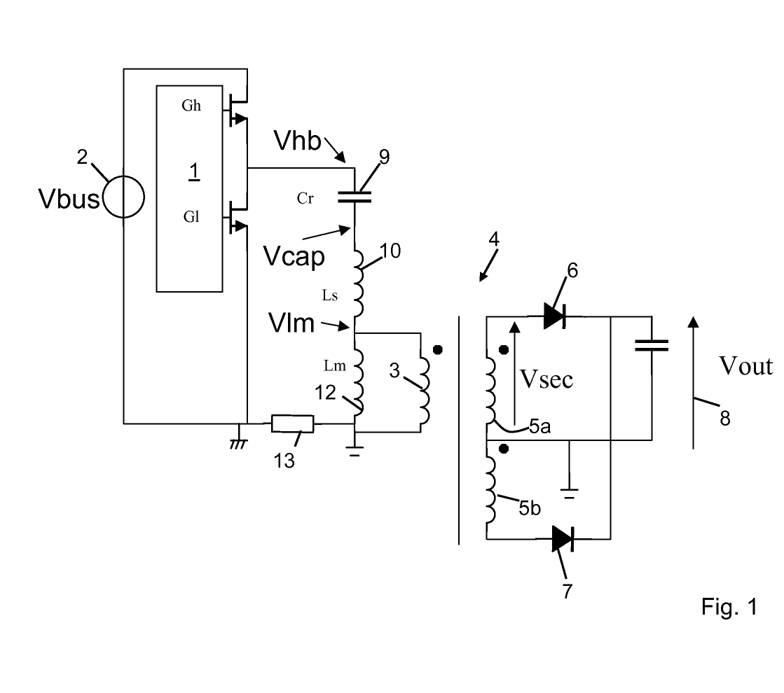

FIG. 1 shows a general circuit diagram of a series resonant or multi-resonant converter;

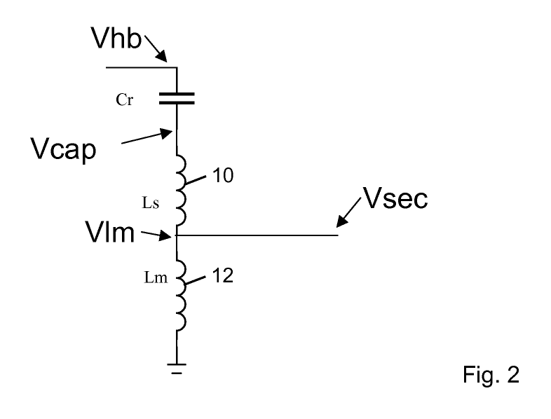

FIG. 2 shows an equivalent circuit of a transformer of the converter of FIG. 1;

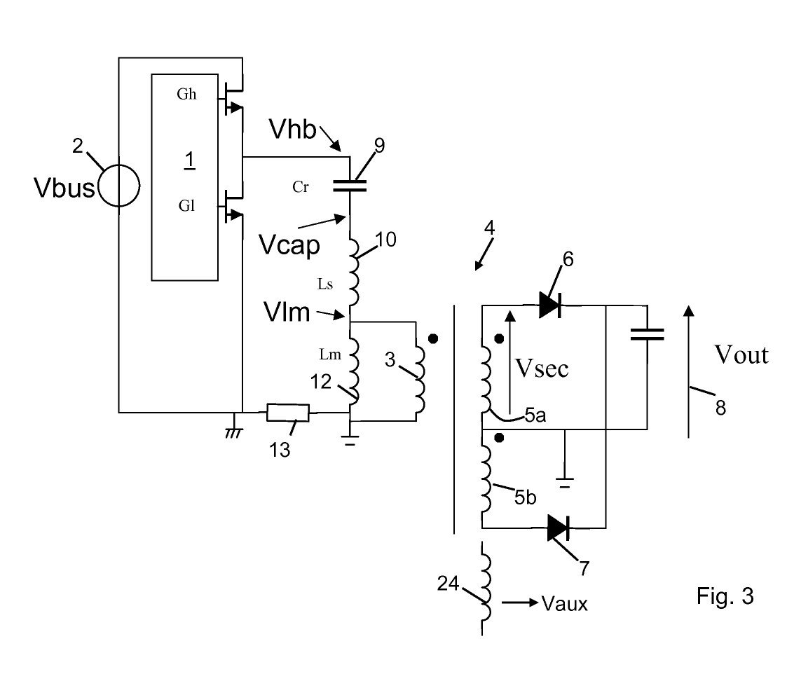

FIG. 3 is similar to FIG. 1 but shows an auxiliary winding associated with the transformer of the converter;

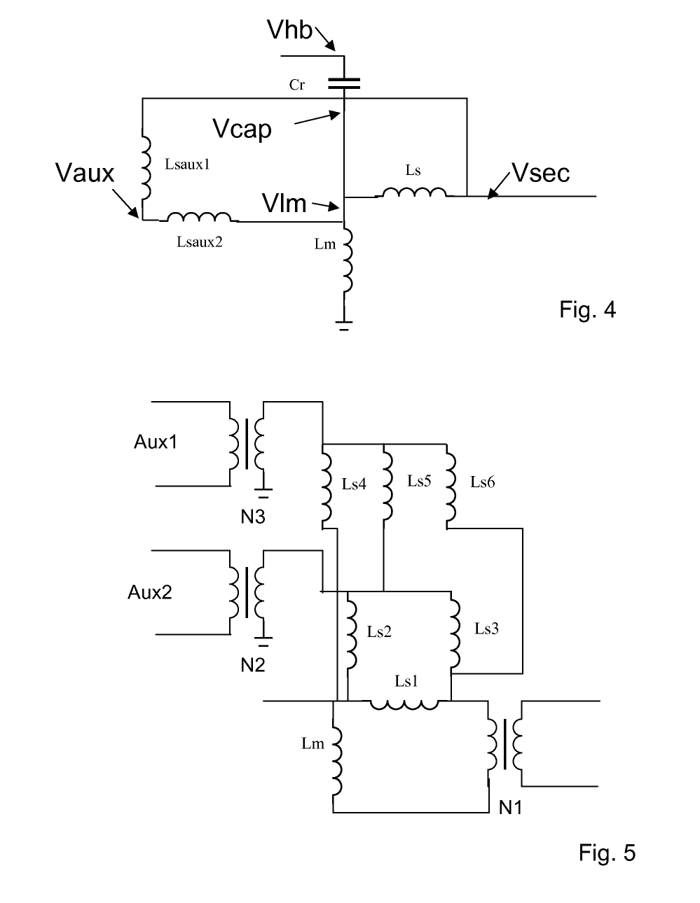

FIG. 4 shows an equivalent circuit of the transformer of FIG. 3, i.e. a transformer having three windings;

FIG. 5 is an equivalent circuit diagram of a multi-winding transformer;

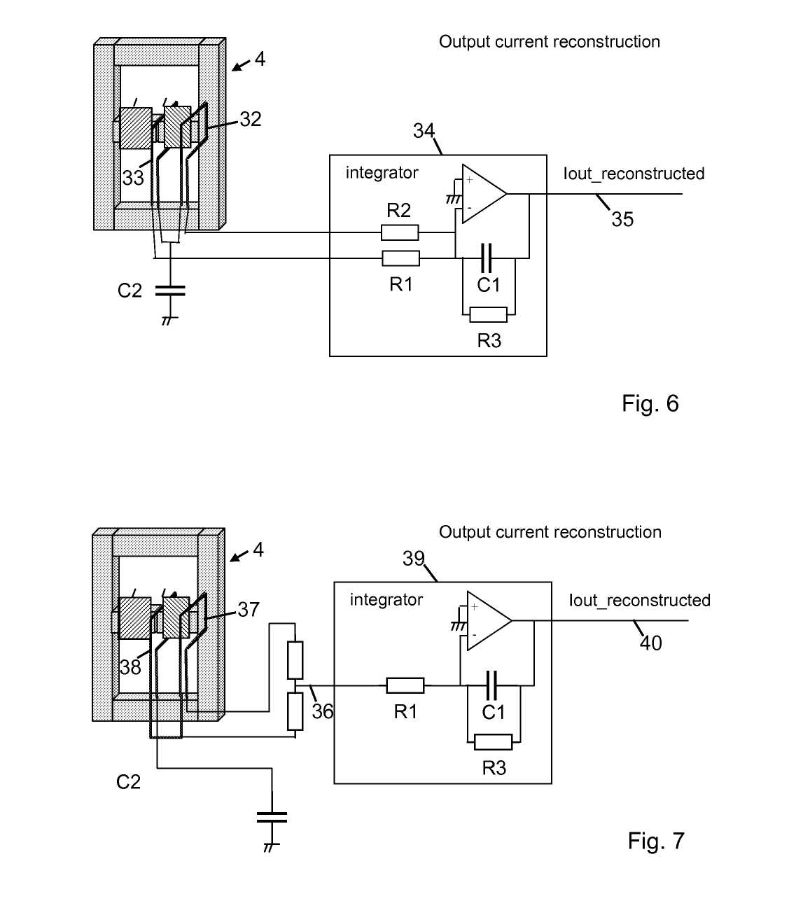

FIG. 6 is a circuit diagram using two auxiliary windings for generating a reconstructed output current;

FIGS. 7 to 10 show alternative auxiliary winding arrangements for producing the reconstructed output current;

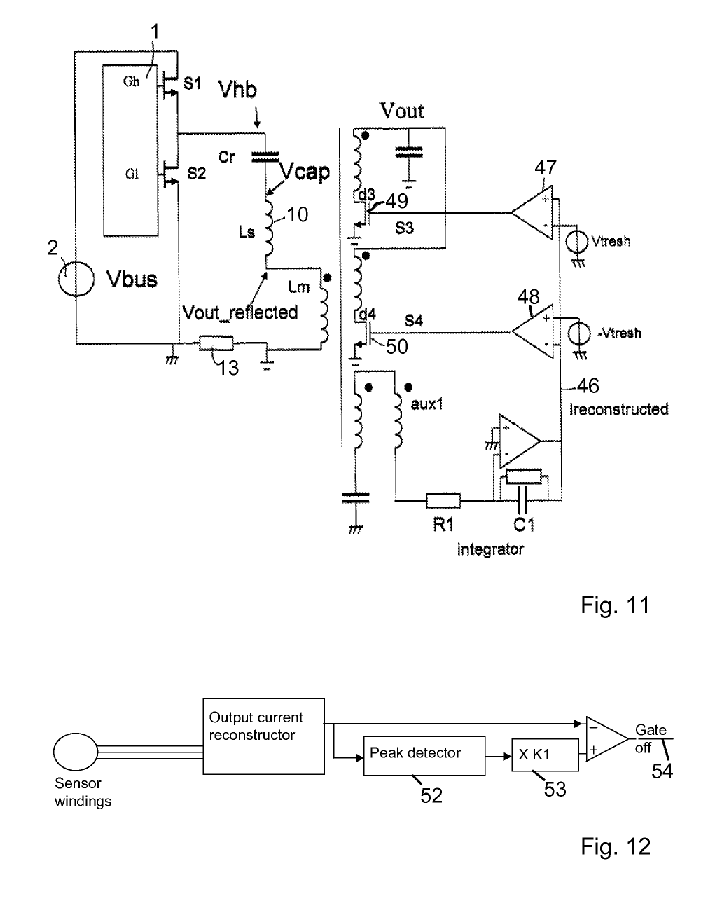

FIG. 11 illustrates control of rectification switches;

FIG. 12 illustrates adaptive control of the rectification switches;

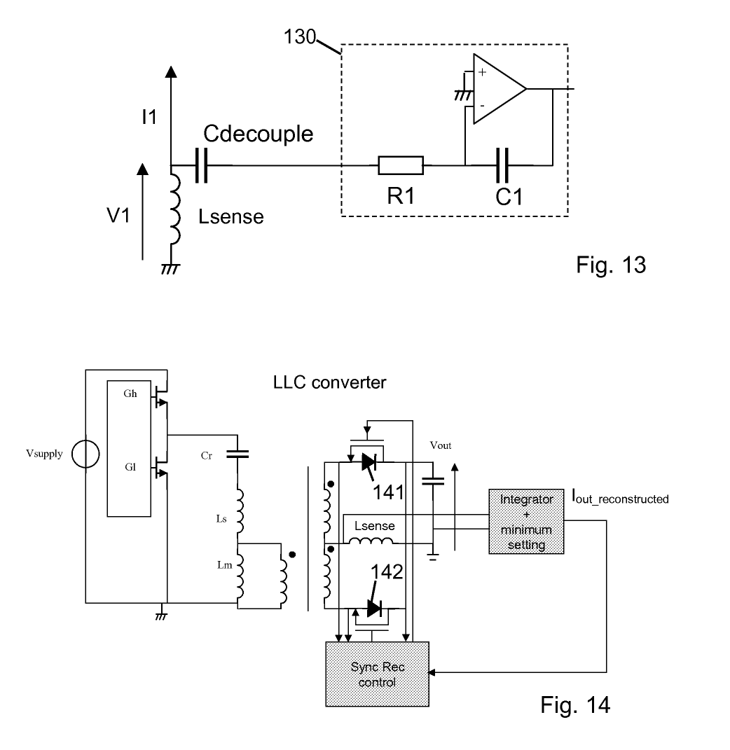

FIG. 13 is a circuit diagram illustrating the principle of current emulation by integration of a voltage signal across an inductor;

FIG. 14 is a circuit diagram of an embodiment comprising a resonant converter with a tapped secondary winding, switches in series with an output voltage and an inductive sensor in series with the tapped winding;

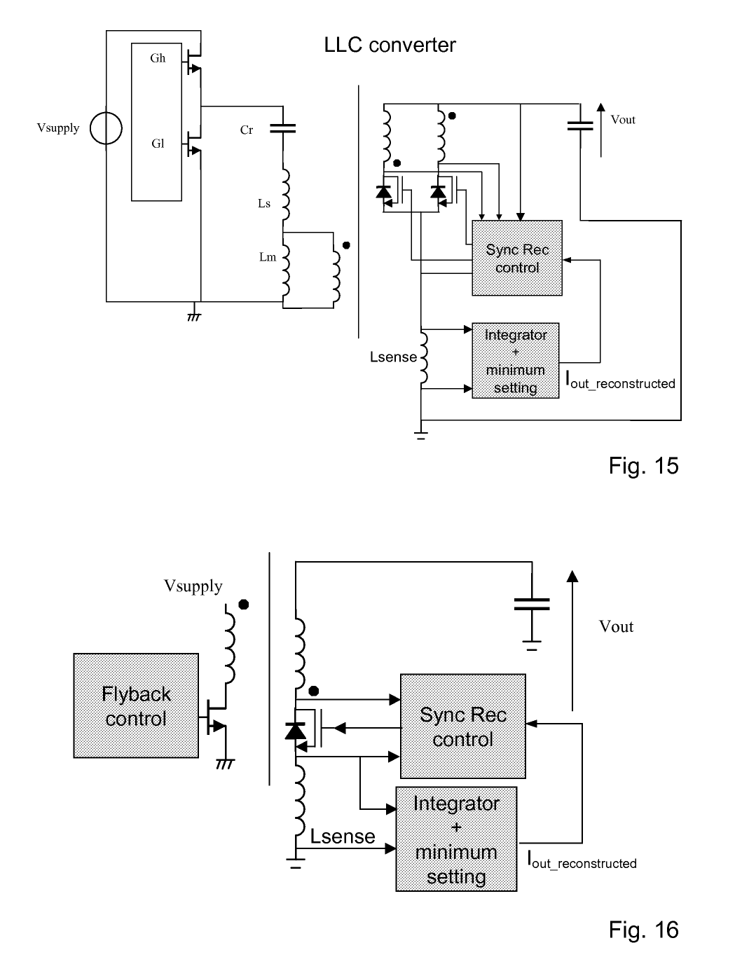

FIG. 15 is a circuit diagram of an embodiment comprising a resonant converter with a tapped secondary winding, switches connected to the ground side of the secondary winding and an inductive sensor in series with a common current path to ground;

FIG. 16 is a circuit diagram of an embodiment comprising a flyback converter with a synchronous switch connected to the ground side and an inductive sensor in series with the common current path to ground;

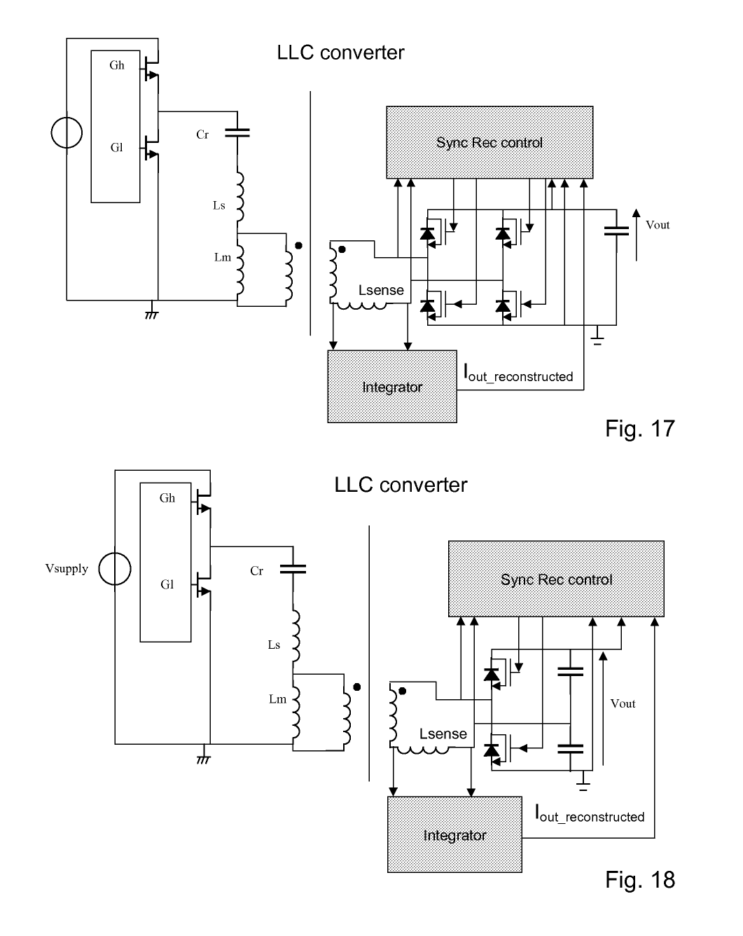

FIGS. 17 and 18 are circuit diagrams of embodiments comprising a single secondary winding;

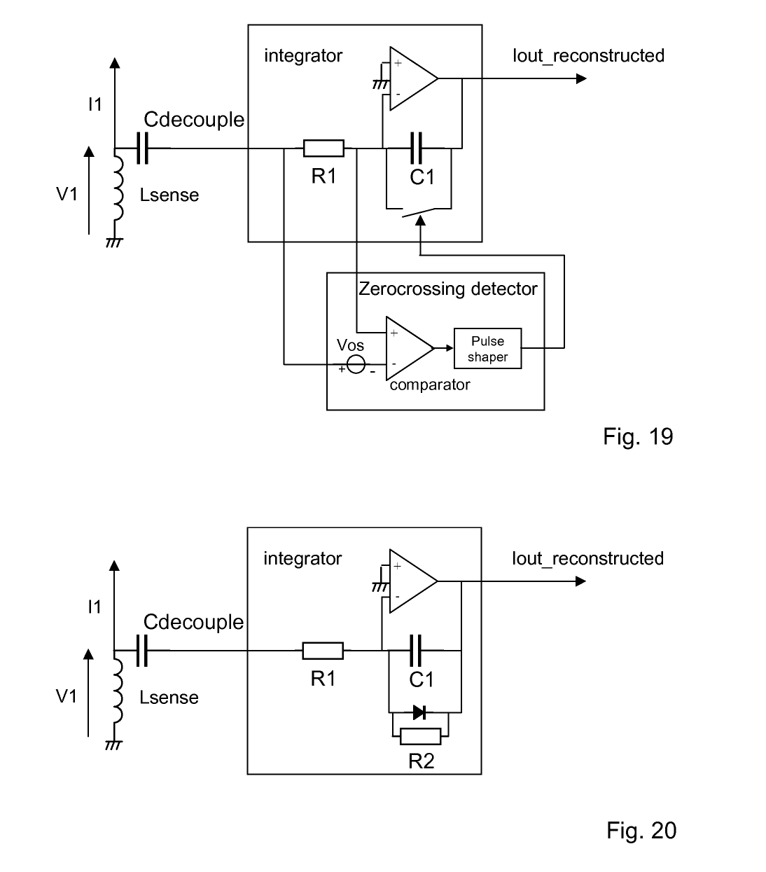

FIGS. 19 to 21 are circuit diagrams illustrating alternative embodiments of an integrator for use with the embodiments of FIGS. 14 to 18; and

FIGS. 22 to 26 are circuit diagrams illustrating alternative embodiments of a rectifier synchronisation control module for use with the embodiments of FIGS. 14 to 18.

A general circuit diagram of a series resonant converter is given in FIG. 1. The converter comprises circuitry 1 for converting a DC input 2 (marked Vbus) into an AC signal which energizes the primary winding 3 of a transformer 4. The induced secondary AC signal across the split secondary winding 5a,5b of the transformer 4 is rectified by second converter circuitry, including two diodes 6 and 7, into a DC output voltage 8 marked Vout for delivering a load current.

The first converter circuitry 1 induces rectangular profile pulses Gh and GI in alternate sequence at a controlled frequency. The pulses are fed to a resonant circuit consisting of a capacitor 9, series leakage inductance 10 and magnetising inductance 12 carrying the magnetising current. The transformer 4 is represented as an ideal transformer with a turns ratio of N:1:1, being the ratio of turns of the primary winding 3, one half 5a of the split secondary winding and the other half 5b of the split secondary winding. The primary winding 3 and the magnetising inductance 12 are shown in parallel, this parallel arrangement carrying the primary current and being in series with the leakage inductance 10 and the capacitor 9. This parallel arrangement is also in series with a sensing resistor 13 which carries the primary current. Thus, the voltage across the resistor 13 is representative of the primary current.

FIG. 2 shows an equivalent circuit of the transformer 4 with leakage inductance 10 modelled at the primary side.

FIG. 3 is similar to FIG. 1 but shows an auxiliary winding 24 associated with the transformer 4.

In FIG. 4, the equivalent circuit diagram with leakage inductance modelled at the secondary side is illustrated. The voltage Vaux is the intermediate voltage of an inductive divider defined by Lsaux₁ and Lsaux₂. The output current flows through this leakage inductance giving a voltage Vls over the leakage inductance Ls given by

$$Vls = Ls \frac{d}{d t} Iout$$

Further, the voltage Vaux is the sum of the voltage Vim across Lm and a part of the voltage Vls across Ls, giving the following equation

Vaux=Vim+k1(Vls)

$$\frac{Laux 2}{Laux 1 + Laux 2}$$

where k1 is the constant

By using two auxiliary windings coupled in different ways to the secondary winding, two of these voltages occur, with a different part of Vls but with a common Vim. If then the voltage difference Vdiff is taken between the two auxiliary windings, this difference represents a fixed part of the voltage across Ls with the Vim terms cancelling one another. The complete equivalent circuit diagram is given in FIG. 5, which illustrates an equivalent model of a 4 winding transformer.

In a resonant converter, a part of the primary current is directly flowing at the secondary side (known as forward action) without this energy first being stored in the magnetizing inductance of the transformer, as with a flyback converter. The magnetising current is not therefore used during energy transfer. The use of two auxiliary windings with a resonant converter allows the output current to be separated from the magnetizing current by taking a difference or sum of the voltages sensed across the two auxiliary windings. This differs from current reconstruction for a flyback converter, for example as disclosed in WO 2004/112229, in which the output current is equal to the magnetizing current, therefore requiring only one auxiliary winding.

In FIG. 5, the terms N2 and N3 are the effective turns ratios which are dependent upon the respective leakage inductances and not on the actual physical turns ratios. Thus, the common Vls terms are also dependent solely on the leakage inductances. Thus, in order to cancel out the common Vim terms, it is necessary to proportion or scale the relative magnitudes of the two Vaux signals. Hence, the actual output current is related to the two voltages across the two auxiliary windings by the following equation

$$Iout = \frac{1}{Ls} \int ( {k}_{3} {Vaux}_{1} - {k}_{4} {Vaux}_{2} ) d t \\ ( as herein defined ) \qquad Equation 1$$

where k₃ and k₄ are the constants necessary to vary the relative magnitudes of the Vaux₁ and the Vaux₂ signals in order to cancel the difference between both Vim terms before integration and Ls is the total equivalent inductance resulting from the individual inductances Ls1 to Ls6 in FIG. 5.

A circuit diagram for generating the reconstructed output current according to Equation 1 is shown in FIG. 6. The two auxiliary windings 32,33 are in series and differently located with respect to the primary and secondary windings of the transformer 4. This results in almost equal components representing the voltage across the magnetising inductance, so these are cancelled after being scaled by R1 and R2 in the integrator 34. The slightly different voltages across the leakage inductance give a difference signal which is integrated in the integrator 34 to provide the reconstructed Iₒᵤₜ signal on line 35. As the common mode voltage across the magnetising inductance is significantly larger than the differential mode voltage across the leakage inductance, the values of the two resistors R1 and R2 should be set accordingly, especially if both windings are located close together. This can be done empirically, for example by checking the signals at an appropriate moment during two successive half cycles and adapting the scaling factors for the integrator (set by R1 and R2) accordingly.

If both windings 32, 33 are close together, the amplitude of the desired differential mode signal becomes smaller and the scaling factor for the common mode term approaches unity, requiring very accurate setting for R1 and R2.

As the secondary windings in the transformer can also be interpreted as a pair of auxiliary windings holding the desired information, the secondary windings can themselves be used to generate a difference signal for providing a reconstructed output current after integration. In this case the slightly different location of the auxiliary windings described above is not needed, because only one of the windings conducts at a time, giving directly the difference in voltage across the leakage inductances, which is related to the time differential (di/dt) of the output current.

Taking into consideration that the difference in voltage is used with a scaling factor close to 1 for one of the windings, the common connection of the windings is essentially not necessary if the subtraction of the common mode term is done already in the transformer by changing the polarity of one winding, that is by connecting the two auxiliary windings in anti-series. The circuit diagram for generating the reconstructed output current is given in FIG. 7. Here the tap 36 between the windings 37,38 is used to adapt the scaling factor of one of the windings to a value just below 1, according to the desired level for cancelling the Vᵢₘ terms. Defining a division factor close to 1 is possible with sufficient accuracy. The signal from the tap 36 is integrated in an integrator 39 to produce the Iₒᵤₜ signal on line 40.

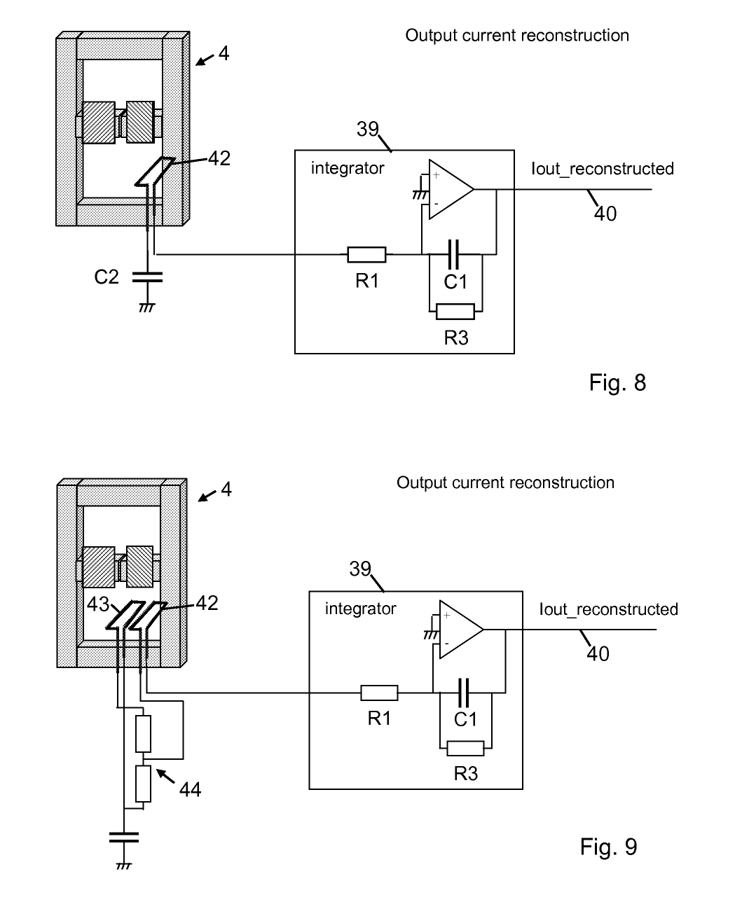

It is possible to apply a dummy resistor in parallel with the other winding, which is not loaded with the resistive divider, to keep a symmetrical load for both windings, however this is in most cases not necessary. It is also possible to leave out the resistive divider if both windings are positioned closely to each other. Leaving out the tap opens the possibility to use only a part of the windings. This leads to the implementation of FIG. 8 using one turn 42.

From the theory presented and experimental measurements it follows that the magnetising term in the load current is almost completely cancelled if the winding is positioned close to the secondary winding. If the winding is close to the primary winding, the magnetising term is almost completely present. This gives a wave shape similar to the primary current. From this effect it follows that with a linear combination of the voltages across two partial windings at a different location it is possible to reconstruct the load current, even if the first winding is not ideally positioned close to the secondary. A schematic diagram of this is given in FIG. 9 where the two partial turns or auxiliary windings are shown at 42,43.

In FIG. 9, the right winding 42, which is in fact the sensing winding, is preferably positioned as far as possible to the right side to get optimum coupling to measure the output current. The left winding 43, that is the compensation winding, is necessary to compensate for the small magnetising current component. Therefore the part of the voltage across the compensation winding to be added can be chosen, for example by a potentiometer shown by the voltage divider 44. If the right side sense winding 42 is optimally positioned, the compensation winding 43 can be omitted.

It can be concluded that a compensation winding is needed if the sensing winding cannot be positioned optimally.

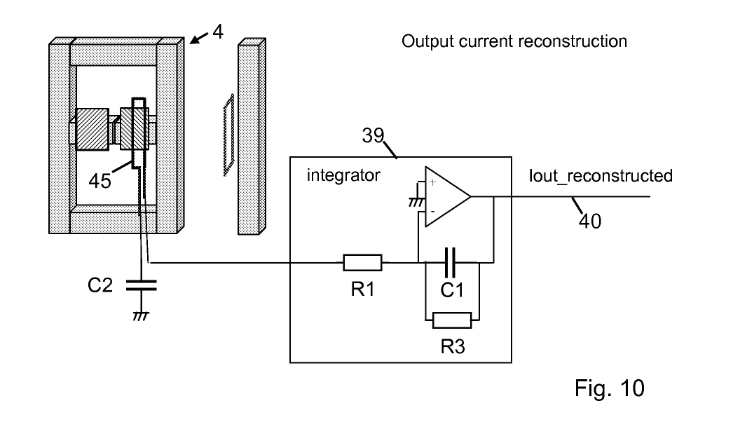

It can also be concluded that a compensation winding 43 is not needed where the sensing winding 42 is positioned optimally. Using a transformer as used in an actual application for mass production it was concluded that a printed sensing wire below the secondary winding is sufficient to get an acceptable representation of the output current. This is illustrated at 45 in FIG. 10, including also a side view of the transformer to show the position of the sensing wire below the transformer on the printed circuit board.

The signal representative of the output current is used to control the synchronous rectification switches in the secondary circuit. The switches are changed between conducting and non-conducting states, in general synchronism with the polarity changes in the output current, in order to provide the required rectification. The turning on of each switch, that is the moment of transition from a non-conducting state to a conducting state, can be accurately timed to occur when the voltage across the switch changes from a negative value to a positive value. For resonant converters, accurate timing of the turn off of each switch is less easy to achieve, because during the on time of the switch, with low Ron and parasitic inductances in the switches in combination with low currents at the end of the conduction interval, low voltage levels occur with additional disturbances due to the di/dt in combination with the parasitic inductances, that make it difficult to detect the actual zero crossing of the current. By recourse to the invention, the reconstructed output current signal is used to control the turn off times of the rectifier switches.

In one preferred method, the magnitude of the output current is used to define the conduction interval of the rectifier switches. A representation of the control of the rectifier switches is shown in FIG. 11. The signal representative of the output current is fed by connection 46 to two comparators 47 and 48, one of which, 47, has a positive value threshold input Vtresh and controls a first rectifying transistor switch 49 and the other of which, 48, has a negative value threshold input −Vtresh and controls a second rectifying switch 50. The first comparator 47 controls the duration of conduction of the switch 49 during each positive half wave of the output current and the second comparator 48 controls the duration of conduction of the switch 50 during each negative half wave of the output current. By this means, the duration of conduction of each switch 49,50 is governed by the profile of the reconstructed output current signal. This enables each rectifying switch to be switched off at a certain phase angle of the generally sinusoidal output current. This is an advantage as in this way delay in the system and switching off at the wrong moment due to offset, parasitic inductances in combination with di/dt and low output currents can be prevented.

The switch on and switch off moment of each switch 49,50 can be governed by a comparison of the magnitude of the output current with a predetermined threshold value which can be a constant value or can be adaptively determined. The preferred adaptive method involves determining the peak value of the reconstructed output current and subsequently switching the relevant rectifier switch off as soon as the current reaches a level that is smaller than a certain fraction of the peak current. This is illustrated in FIG. 12 which shows peak detection at 52 and the fraction thereof at 53, the signal to turn off the gate of the rectifier switch being indicated at 54.

The embodiments described above all include auxiliary winding circuitry, or sensing loops, coupled to the leakage inductance at the secondary side of the transformer as part of the detecting circuitry for deriving an electrical signal representative of the output current of the converter. Such auxiliary windings are provided in the form of at least a partial turn around a part of the transformer core. Integrating the voltage across such auxiliary windings provides sufficient information to reconstruct the output current. This provides for a good representation of the output current without extra losses, and with sufficient amplitude to enable a fast comparator action possible, allowing for digital control of the synchronization switches.

An alternative way of achieving the desired result, which has similar benefits to the above described embodiments, is to use a small inductor in series with the output current path of the converter as the voltage sensing portion of the detecting circuitry. The small inductor, which is preferably of the order of 10-50 nH, may for example be provided by a short length of wire, which is in most cases already present on the printed circuit board. Converting the voltage across the inductor into a signal representative of the output current may be carried out in the same or similar way as described above for the embodiments incorporating auxiliary windings.

The inductor can be placed in series with the winding or windings in various different ways, described as follows.

One possibility is that the inductor is connected to sense the total output current, while the minimum value of the output current is approximately zero. This is the case for a resonant converter with a tapped output winding, or for a flyback converter. The minimum value of the signal at the integrator output may be set to zero by adapting the integration constant.

A further possibility is to connect the inductor such that a mainly AC current flows through the inductor. This is the case for a resonant converter with an output winding using a bridge rectifier or a halfbridge rectifier. A standard integrator with an integration constant selected according to an average value of 0 can be used.

The synchronous rectifier switches can be controlled using the reconstructed value of the output current derived from the inductor. If the reconstructed value is detected to cross a predefined level, this is used as an indication that a synchronous rectifier switch should be turned on or off.

A switch-on moment can be determined by the voltage across a switch, the representation of the output current crossing a predefined level, or a combination of both, while a switch-off moment can be fully determined by the reconstructed output current.

A first part of the current reconstruction involves sensing a voltage across an inductor in series with the outputcurrent path of a switched mode converter. FIG. 13 illustrates this basic principle of current emulation, by means of sensing and integrating a voltage across an inductor. The sensed voltage V1 across inductor Lₛₑₙₛₑ is input to an integrator 130, the inductor Lₛₑₙₛₑ being preferably but not necessarily decoupled from the integrator 130 by a decoupling capacitor C_{decouple}. The output of the integrator 130 provides a reconstructed current signal. In an exemplary embodiment, an inductor Lₛₑₙₛₑ of approximately 50 nH based on an aircoil of copper wire of approximately 5 cm in length was used with an integrator based on an AD8615 op-amp with R1=100 Ohms and C1=900 pF. The inductor Lₛₑₙₛₑ was connected according to the embodiment illustrated in FIG. 14, and a resistor was connected in parallel with C1 to set the integration constant. The inductance may be provided by a shorter length of wire in combination with a ferrite ring. An example of a shorter wire used in this was a wire of approximately 2 cm in length with a small ferrite toroid (3 mm diameter, 5 mm length, airgap 0.1 mm), the wire being capable of carrying peak currents of 25 A with a 40 nH inductance.

The embodiment illustrated in FIG. 14 comprises a resonant converter with a tapped winding, with controllable switches 141, 142 in series with the output voltage Vout and an inductive sensor Lsense in series with the tapped winding.

FIG. 15 illustrates an alternative embodiment, in which a resonant converter with a tapped winding is used with controllable switches connected to the ground side of the secondary side and an inductive sensor Lₛₑₙₛₑ in series with a common current path to ground.

FIG. 16 illustrates a further embodiment comprising a flyback converter with a synchronous switch connected to the ground side of the secondary side of the converter and an inductive sensor Lₛₑₙₛₑ in series with the output voltage Vₒᵤₜ.

FIGS. 17 and 18 illustrate embodiments in which a single secondary winding is used instead of a tapped winding. Using a single winding has the advantage of resulting in smaller losses in the transformer and simplifies transformer construction. In these embodiments, the average value of the integrator output, rather than the minimum value, corresponds with a zero current level, because in this case the sensed current is not rectified. The zero level setting (the integration constant) can for example be realized by a resistor in parallel with the integrator capacitor, for example as shown in FIG. 20 illustrating an op-amp implementation of the integrator, but without the diode. Furthermore, in the case of the use of a single secondary winding the voltage across the sensing element Lₛₑₙₛₑ is not referenced to a fixed voltage (such as ground), which requires the use of a differential input for the integrator.

The embodiments illustrated in FIGS. 17 and 18 may be further modified by placing the inductive sensor Lₛₑₙₛₑ in series with the output capacitor, i.e. after the rectifier, resulting in a similar situation to that of the embodiments of FIGS. 14 and 15.

FIG. 19 illustrates a detailed circuit diagram of the integrator module with minimum setting, as shown in FIGS. 14 to 16. In this integrator circuit, The integrator generates a reconstructed current signal output, Iₒᵤₜ_{_{—}}_{reconstructed}, with a wave shape equal to the current I1. The zero crossing detector module is configured to detect a time interval close to the moment that the slope in the output current changes from negative to zero or positive. The transition from a negative slope of the current I1 (corresponding to a positive voltage across the inductor Lₛₑₙₛₑ) to a non negative slope of the current I1 (corresponding to a zero or positive voltage across Lₛₑₙₛₑ) is detected by a comparator with an offset voltage Vₒₛ to be able to define the actual level for the slope. A pulse shaper or equivalent circuit is added, which is configured to discharge the integrator capacitor C1 during a time window close to the zero crossing of the voltage V1 across the inductor. With this discharge interval the minimum value of the integrator output is set to 0, according to the minimum value of I1.

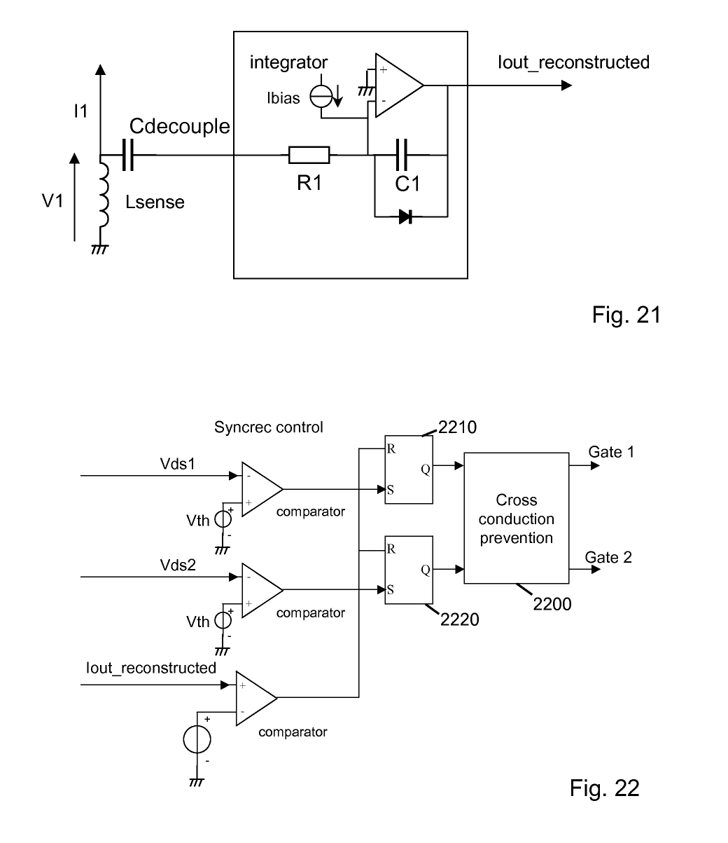

Other embodiments of the integrator with minimum setting are illustrated in FIG. 20 and FIG. 21. In these embodiments, a diode is used to clamp the reconstructed current signal Iₒᵤₜ_{_{—}}_{reconstructed} to a minimum value according to the minimum current in the inductor Lₛₑₙₛₑ. To ensure that the diode always conducts during a small part of the period around the interval where the minimum current in the inductor Lₛₑₙₛₑ occurs, a series resistor R1, or a current bias, is necessary. The diode function may alternatively be realised by an active diode.

In FIGS. 22, 23 and 24, alternative embodiments of the syncrec control (rectifier synchronisation control) module for the embodiment of FIG. 15 are illustrated.

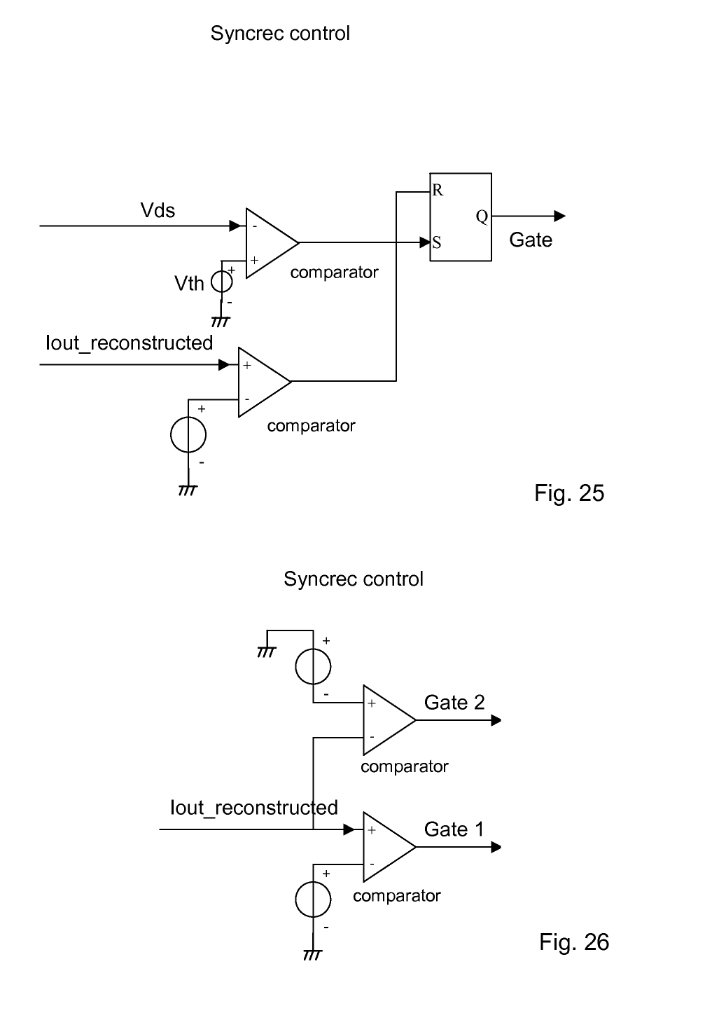

In FIG. 25 an embodiment of the syncrec control module for the embodiment of FIG. 16 is illustrated.

In FIG. 26 an embodiment of the syncrec control module for the embodiments of FIGS. 17 and 18 is illustrated.

In the syncrec control module illustrated in FIG. 22, the switch is turned on by reaching a certain forward voltage, for example 0.5V (Vds=−0.5V). The switch is turned off when the reconstructed output current reaches a level close to 0. A cross conduction prevention block is included in the module to prevent both switches being on at the same time. The function of the cross-conduction prevention module 2200 may alternatively be provided by making the set or reset operation of each of the two latches 2210 dependent on the state of the other latch 2220, in order to ensure the right timing for both switches.

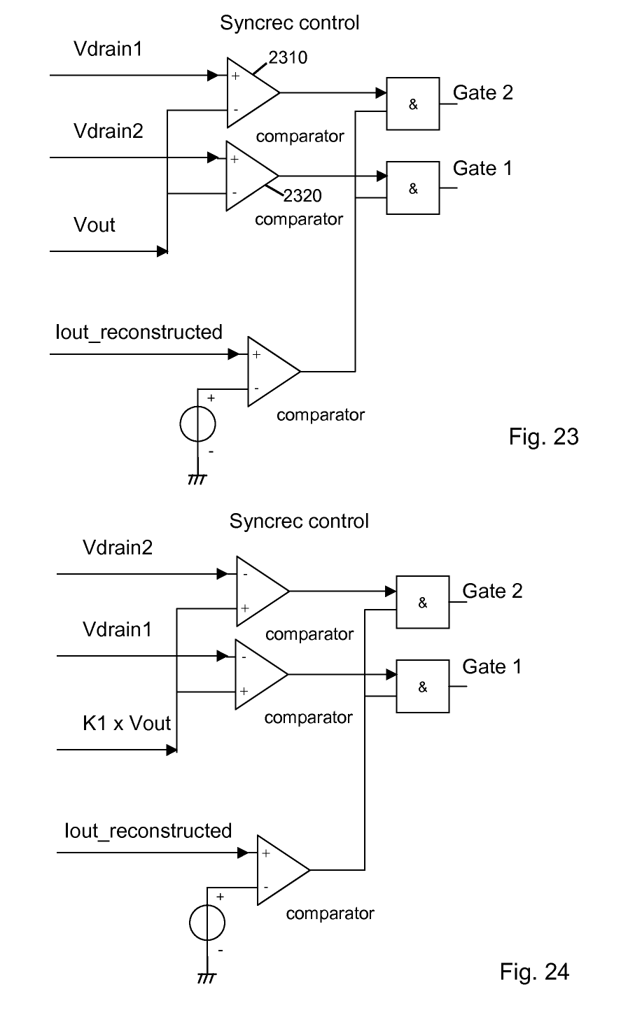

In the syncrec control module embodiment illustrated in FIG. 23, the reconstructed output current is compared with a positive level close to 0 to get a certain non overlap time for the on state of the switches. The actual switch that is allowed to conduct is determined by the drain voltage of the opposite switch becoming larger than V_{out.}, as determined by the outputs from comparators 2310, 2320 configured to compare the drain voltages V_{drain1}, V_{drain2} with the output voltage Vₒᵤₜ.

In the alternative syncrec control module embodiment illustrated in FIG. 24, the reconstructed output current is again compared with a positive level close to 0 to get a certain non overlap time for the on state of the switches. The actual switch that is allowed to conduct is determined by the drain voltage of a corresponding switch to become smaller than a the output voltage Vₒᵤₜ multiplied by a factor K1.

Using the syncrec control module embodiment illustrated in FIG. 26 in the embodiment illustrated in FIG. 17, the output control signals gate1, gate 2 can each be used to drive pairs of switches in the full bridge version illustrated in FIG. 17.

In a general aspect, an electrical resonant power converter according to the above described embodiments incorporates a rectifier synchronisation control module configured to provide switching signals for controlling one or more rectifier switches on the secondary side of the converter by comparing the reconstructed current signal from the integrator with a constant preset voltage signal. The rectifier synchronisation control module may also be configured to control switching operations of the one or more switches by comparison of a drain voltage of the one or more switches with a threshold voltage or with a signal proportional or equal to the output voltage of the converter.

From reading the present disclosure, other variations and modifications will be apparent to persons skilled in the art. Such variations and modifications may involve equivalent and other features which are already known in the art, and which may be used instead of or in addition to features already described herein, for example in terms of variations on the multi-resonant converter concept such as the LCC converter.

Although claims have been formulated in this application to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The applicants hereby give notice that new claims may be formulated to such features and/or combinations of such features during the prosecution of the present application or of any further application derived therefrom.

1. An electrical resonant power converter comprising:
a transformer having a primary circuit and a secondary circuit, the primary circuit being energisable by an AC signal to induce a secondary AC signal across the secondary circuit for delivering an output current; and
detecting circuitry for deriving an electrical signal representative of the output current,
wherein the secondary circuit has rectification switches having a switching function for rectifying the secondary AC signal and control circuitry for controlling the timing of the switching function in dependence upon the variation with time of the magnitude of the electrical signal representative of the output current.

2. A converter according to claim 1, wherein the detecting circuitry includes auxiliary winding circuitry associated with the transformer.

3. A converter according to claim 2, wherein the auxiliary winding circuitry comprises two auxiliary windings arranged in series or anti-series.

4. The converter according to claim 1 wherein first and second windings of the secondary circuit provide the auxiliary winding circuitry.

5. A converter according to claim 3 wherein the detecting circuitry is configured to derive the electrical signal representative of the output current from a difference or sum of voltages across the two auxiliary windings.

6. A converter according to claim 2, wherein the auxiliary winding circuitry comprises a single auxiliary winding.

7. A converter according to claim 6, wherein the single auxiliary winding is a sensing loop external to the transformer.

8. A converter according to claim 1 wherein the detecting circuitry comprises an integrator connected to the auxiliary winding circuitry, the integrator configured to integrate a voltage sensed across the auxiliary winding circuitry to provide the electrical signal representative of the output current.

9. A converter according to claim 1, wherein the control circuitry includes comparators operative to compare the magnitude of the signal representative of the output current with respective threshold values.

10. A converter according to claim 9, wherein the threshold values are constant.

11. A converter according to claim 9, wherein the threshold values for switch off of the rectification switches are adaptively determined, being a proportion of the maximum amplitude of the signal representative of the output current.

12. A method of operating an electrical resonant power converter comprising a transformer having a primary circuit and a secondary circuit, the primary circuit being energised by an AC signal to induce a secondary AC signal across the secondary circuit for delivering an output current, the method comprising deriving from the secondary circuit an electrical signal representative of the output current and employing the variation with time of the electrical signal representative of the output current to control the timing of the switching function of rectification switches which rectify the secondary AC signal.

13. The method of claim 12 wherein the electrical signal representative of the output current is derived from a sensed voltage across the auxiliary winding circuitry.

14. The method of claim 13 wherein the auxiliary winding circuitry comprises two auxiliary windings arranged in series or anti-series.

15. The method of claim 14 wherein the electrical signal representative of the output current is derived from a difference or sum of the sensed voltages across the two auxiliary windings.

16. An electrical power converter comprising:
a transformer having a primary circuit and a secondary circuit, the primary circuit being energisable by an AC signal to induce a secondary AC signal across the secondary circuit for delivering an output current; and
detecting circuitry for deriving an electrical signal representative of the output current, the detecting circuitry comprising an inductor in series with the secondary circuit of the transformer;
wherein the secondary circuit has one or more rectification switches having a switching function for rectifying the secondary AC signal and control circuitry for controlling the timing of the switching function in dependence upon the variation with time of the magnitude of the electrical signal representative of the output current.

17. The electrical power converter of claim 16 wherein the converter is a flyback power converter.

18. The electrical power converter of claim 16 wherein the detecting circuitry comprises an integrator connected to the inductor, the integrator configured to integrate a voltage across the inductor to provide the electrical signal representative of the output current.

19. A method of operating an electrical power converter comprising a transformer having a primary circuit and a secondary circuit, the primary circuit being energised by an AC signal to induce a secondary AC signal across the secondary circuit for delivering an output current, the method comprising deriving an electrical signal representative of the output current from a voltage measured across an inductor in series with the secondary circuit of the transformer and employing the variation with time of the electrical signal representative of the output current to control the timing of the switching function of one or more rectification switches which rectify the secondary AC signal.
